(19) United States
(12) Patent Application Publication
(10) Pub. No.: US 2012/0151581 A1
(43) Pub. Date: Jun. 14, 2012

(54) METHOD AND SYSTEM FOR INFORMATION PROPERTY MANAGEMENT

(75) Inventors: Dong Ho KANG, Daejeon (KR); Beom-Hwan CHANG, Daejeon (KR)

(73) Assignee: Electronics and Telecommunications Research Institute, Daejeon (KR)

(21) Appl. No.: 13/316,390

(22) Filed: Dec. 9, 2011

(30) Foreign Application Priority Data
Dec. 9, 2010 (KR) 10-2010-0125849

(51) Int. Cl. G06F 21/00

(52) U.S. Cl. 726/22

(57) ABSTRACT

A system for managing sensitive information property, includes a monitoring agent installed in a host system needed for sensitive information property management and configured to monitor the sensitive information property; an information property storage configured to store a list of the sensitive information property for the host system; and an information property manager configured to determine whether or not the sensitive property has leaked.

### CROSS-REFERENCE TO RELATED APPLICATION(S)

The present invention claims priority of Korean Patent Application No. 10-2010-0125849, filed on Dec. 9, 2010, which is incorporated herein by reference.

### FIELD OF THE INVENTION

The present invention relates to a technique for managing information property, and more particularly, to a system and method for managing sensitive information property in a host system needed for sensitive information property management.

### BACKGROUND OF THE INVENTION

Typically, a technology for protecting sensitive information property mainly involves a method that prevents an unauthorized user from accessing sensitive information property.

In view of a system end, a technology for protecting sensitive information property involves monitoring files going out via input/output devices such as USB storage devices, CD-ROMs, and printers by a user. For a network, a mainstream technology for protecting sensitive information property involves monitoring data on network such as email, messenger, etc.

However, the technologies for information leak prevention, most of which performs mainly on the monitoring of the input/output devices or the network, has the problem that accurate information cannot be obtained in advance about which information property leaks out when figuring out sensitive information about each system in host system needed for sensitive information property management and in the event of physical leakage of the system.

### ABSTRACT OF THE INVENTION

In view of the above, the present invention provides a system and method for managing sensitive information property in host system needed for sensitive information property management.

In accordance with a first aspect of the present invention, there is provided a system for managing sensitive information property, which includes:

a monitoring agent installed in a host system needed for sensitive information property management and configured to monitor the sensitive information property;

an information property storage configured to store a list of the sensitive information property for the host system; and

an information property manager configured to determine whether or not the sensitive property has leaked.

Further, the information property manager includes:

a document converter configured to convert a given file containing sensitive information into a text file;

a keyword generator configured to extract one or more keywords from the text file, the keywords being used for determining whether or not a file to be monitored in the host system is a valuable file having sensitive information property;

a keyword storage unit configured to store the keywords; and

an analyzer configured to determine the importance of the monitored file in the host system based on the keywords.

Further, the analyzer includes:

a reception unit configured to receive a abstract of the monitored file from the monitoring agent;

a similarity analysis unit configured to check the presence or absence of a word in the abstract related to the keywords to determine the degree of importance of the monitored file; and

a registration unit configured to register the monitored file as the valuable file when the monitored file is determined to have the importance by the similarity analysis unit.

Further, the similarity analysis unit is configured to determine the importance of the monitored file by using a binary tree of the keywords.

Further, the registration unit is further configured to store information on the monitoring agent upon registration of the valuable file.

Further, the monitoring agent includes:

a file monitor configured to monitor a file in the host system;

a document converter configured to convert the monitored file into a text file; and

a document abstracter configured to produce the abstract of the text file.

In accordance with a second aspect of the present invention, there is provided an information property manager including:

a document converter configured to convert a given file containing sensitive information into a text file;

a keyword generator configured to extract one or more keywords from the text file, the keywords being used for determining whether or not a file to be monitored is a valuable file having sensitive information property;

a keyword storage unit configured to store the keywords; and

an analyzer configured to determine the importance of the monitored file based on the keywords.

In accordance with a third aspect of the present invention, there is provided a method for managing sensitive information property in a host system, including:

monitoring a leakage of the sensitive information property in the host system; and

figuring out the status of sensitive information property of the host system to determine whether or not the sensitive property has leaked.

Further, said figuring out figuring out the status of sensitive information property of the host system includes:

converting a given file into a text file;

extracting one or more keywords used to determine whether a file to be monitored is a valuable file having sensitive information property;

producing a abstract of the monitored file from the host system; and

analyzing the importance of the monitored file based on the keyword to determine whether or not the monitored file is the valuable file.

Further, said analyzing the importance of the monitored file includes:

receiving the abstract of the monitored file from the host system; and

determining the importance of the monitored file by checking the presence or absence of words related to the keywords in the abstract.

Further, the method further includes:

registering the monitored file as the valuable file when the monitored file is determined to have the importance.

Further, said registering the file as the valuable file includes:

storing information on a monitoring entity of the monitored file upon registration of the monitored file.

### BRIEF DESCRIPTION OF THE DRAWINGS

The above and other objects and features of the present invention will become apparent from the following description of embodiments, given in conjunction with the accompanying drawings, in which:

FIG. 1 illustrates a schematic block diagram of a system for managing information property in accordance with an embodiment of the present invention;

FIG. 2 presents a configuration of a binary tree for keywords extracted from a given document in accordance with the embodiment of the present invention;

FIG. 3 illustrates a detailed block diagram of the similarity analyzer shown in FIG. 1;

FIG. 4 provides a procedure for searching a word ‘E’ in an abstract by tracing a binary tree node in accordance with an embodiment of the present invention; and

FIG. 5 is a flowchart illustrating a method for managing sensitive information property in accordance with an embodiment of the present invention.

### DETAILED DESCRIPTION OF THE EMBODIMENTS

Hereinafter, an embodiment of the present invention will be described in detail with reference to the accompanying drawings.

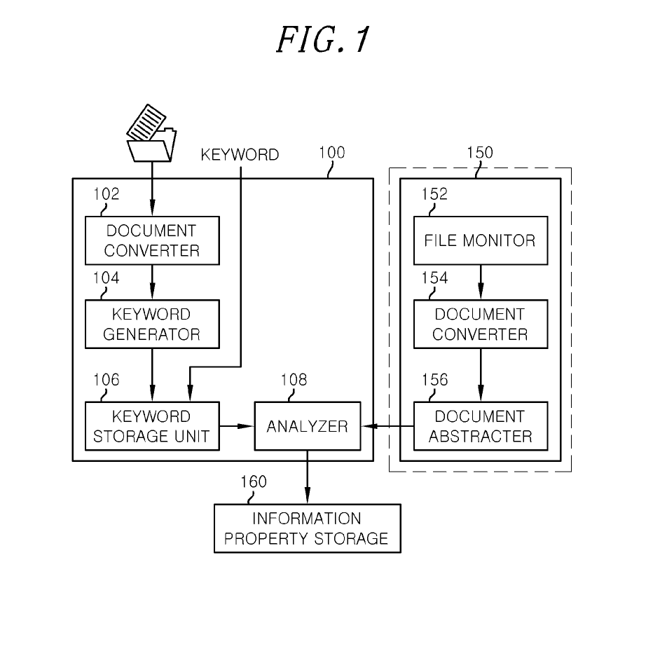

FIG. 1 illustrates a schematic block diagram of a system for managing information property in accordance with an embodiment of the present invention.

The system for managing information property includes an information property manager 100, an information property storage 160, and a monitoring agent 150.

The monitoring agent 150 is installed in each host system 100 needed for information property management.

The information property manager 100 receives an abstract of information property such as a file to be monitored in the host system 100, and determines the degree of importance of the information contained in the monitored file. If it is regarded as sensitive information property, the monitored file and the information on the host system are stored in the information property storage 160 for the management thereof. As shown in FIG. 1, the information property manager 100 includes a document converter 102, a keyword generator 104, a keyword storage unit 106 and an analyzer 108.

Upon receipt of a given file containing sensitive information by a user, the information property manager 100 converts the given file into a text file in a text format by using the document converter 102.

Then, the information property manager 100 automatically extracts keywords from the converted text file by using the keyword generator 104 to be used for determining whether or not a file to be monitored in the host system 110 is a valuable file having the sensitive information property. The keywords are chosen depending on how many times a word in a document is repeated. To this end, all the keywords in the document are constructed in a binary tree to calculate the level of repetition.

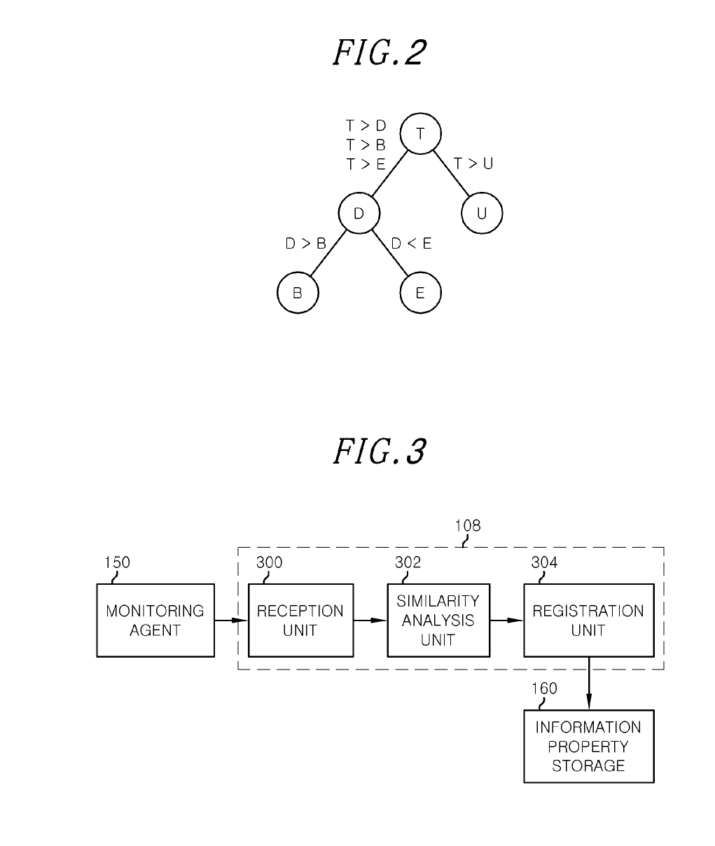

FIG. 2 shows a configuration of a binary tree for on or more keywords extracted from a document.

For example, when words T, D, U, B, E in a document are appeared in the order of T->D->U->B->E, the keyword generator 104 in the information property manager 100 puts the word T into a root node. If a unicode value of a next word is less than that of the word T, the next word is inserted into a left child node. However, if a unicode value of a next word is larger than that of the word T, the next word is inserted into a right child node.

In case where a same word appears in a next sequence, the level of repetition for a corresponding node is increased and the word with high repeatability in the document is automatically extracted as a keyword. The information property manager 100 then stores the extracted keywords in the keyword storage unit 106. In accordance with the present invention, a keyword chosen by a user may also be stored in the keyword storage unit 106.

Meanwhile, the analyzer 108 receives an abstract of the monitored file by the monitoring agent 150 installed in the host system 110, and determines the degree of importance of the monitored file based on the keywords stored in the keyword storage unit 106.

FIG. 3 illustrates a detailed block diagram of the analyzer 108 shown in FIG. 1.

Referring to FIG. 3, the analyzer 108 includes a reception unit 300, a similarity analysis unit 302, and a registration unit 304.

The reception unit 300 receives an abstract of a monitored file that a user has accessed or that has leaked out from the monitoring agent 150. The abstract is then provided to the similarity analysis unit 302.

The similarity analysis unit 302 checks that words in the abstract are related with the keywords stored in the keyword storage unit 106. If a word related to the keywords is present, the repeatability of the word is checked to determine the degree of importance of the monitored file. If the monitored file is determined to be a sensitive document, the registration unit 304 stores the monitored file into the information property storage 160 along with information on the monitoring agent 150 and registers the monitored file as the valuable file having information property.

In determining the degree of importance of the monitored file, the similarity analysis unit 302 determines the degree of importance of the monitored file while maintaining the binary tree node for the keywords.

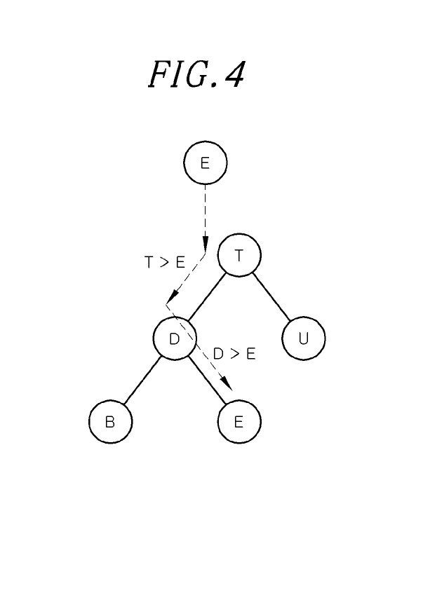

FIG. 4 provides a procedure for searching a word E in a abstract by tracing a binary tree in accordance with an embodiment of the present invention.

The abstract has a collection of main words in the monitored file. As shown in FIG. 4, the similarity analysis unit 302 traces the binary tree node to search for each word in the abstract. If a keyword corresponding to a word is present in the binary tree node, the similarity analysis unit 302 calculates the repeatability of the keyword. The calculated repeatability of the keyword is used as criteria for evaluating the degree of importance of the abstract of the monitored file.

Referring back to FIG. 1, the monitoring agent 150 includes a file monitor 152, a document converter 154 and document abstracter 156.

The file monitor 152 monitors the user's access to a file in the host system 100, and delivers the monitored file to the document converter 154.

The document converter 154 converts the monitored file from the file monitor 152 into a text file in a text format, and delivers the converted text file to the document abstracter 154. The document abstracter 156 produces an abstract of the text file delivered from the document converter 154, and transmits the abstract to the information property manager 100. The abstract may be produced in a similar manner to that the keyword generator 104 extracts the keywords.

The information property storage 160 stores a list of registered valuable files for each host system, and serial numbers or radio frequency identification (RFIDs) for identifying the host systems. The serial numbers or radio frequency identification (RFID) may be used to present the position of the information property and to identify the information property to prevent the leakage of the property in a system identifier.

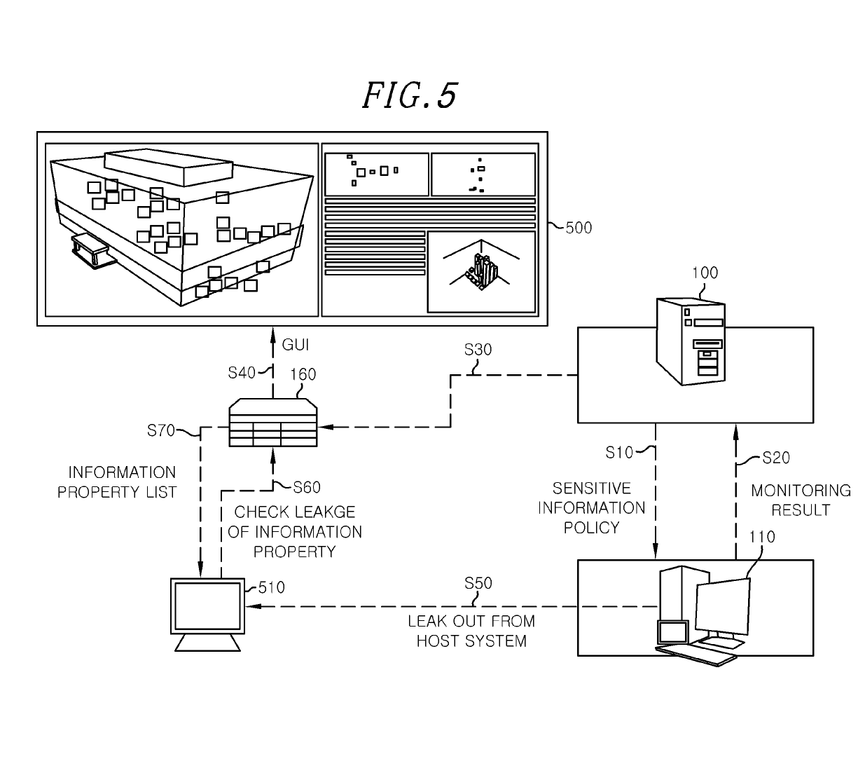

FIG. 5 is a flowchart illustrating a method for performing information property management in accordance with an embodiment of the present invention. Hereinafter, the method of the present invention will be described in detail with reference to FIGS. 1 and 3 along with FIG. 5.

First, in step S10, the information property manager 100 supplies a management policy for sensitive information property with the monitoring agent 150 installed in the host system 110.

Next, in step S20, the monitoring agent 150 in the host system 10 performs monitoring of sensitive information property based on the management policy provided from the information property manager 100, and transmits monitoring results including the current status for sensitive information property in the host system 100.

Subsequently, upon receiving information property manager the monitoring results from the monitoring agent 150, in step S30, the information property manager 100 deliveries the monitoring results to the information property storage 160 for storing thereof.

Optionally, in step S40, the sensitive information property for each host system 100 may be displayed on a screen 500 through the graphic user interface. As shown in FIG. 5, physical positions and property statement of the information property for each host system are presented on the screen 500, so that a manager can easily acknowledge and manage the sensitive information property for each host system.

During monitoring the sensitive information property for the host system 100, there may be monitored a leakage of a file from the host system 100 as indicated in step S50, and the monitoring agent 150 may inform the leakage of sensitive information property of the manager, e.g., through the use of his/her monitoring terminal 510.

In order to check whether or not sensitive information property has leaked out, in step S60, the manager sends the information property storage 160 a request for a list of information property and the serial numbers or RFIDs for the host system 100.

Upon receipt of the list of information property and the serial numbers or RFIDs for the host system 100 from the information property storage 160, in step S70, it is determined whether or not the monitored file has leaked out by checking the list. The manager takes an appropriate countermeasure to prevent the leakage of sensitive information property in accordance with a determination result. For example, a system identifier identifies the information property, i.e., a leaked file using the serial numbers or RFIDs and close the passage of the leaked file.

As described above, in accordance with the present invention, it is possible to effectively protect and manage sensitive information property in each host system for sensitive information property management by installing a monitoring agent, figuring out the status of the sensitive information property of the host system through the monitoring agent, and monitoring the leakage of the sensitive information property by an unauthorized user.

While the invention has been shown and described with respect to the particular embodiments, it will be understood by those skilled in the art that various changes and modification may be made without departing the scope of the present invention as defined in the following claims.

What is claimed is:

1. A system for managing sensitive information property, comprising:
a monitoring agent installed in a host system needed for sensitive information property management and configured to monitor the sensitive information property;
an information property storage configured to store a list of the sensitive information property for the host system; and
an information property manager configured to determine whether or not the sensitive property has leaked.

2. The system of claim 1, the information property manager comprising:
a document converter configured to convert a given file containing sensitive information into a text file;
a keyword generator configured to extract one or more keywords from the text file, the keywords being used for determining whether or not a file to be monitored in the host system is a valuable file having sensitive information property;
a keyword storage unit configured to store the keywords; and
an analyzer configured to determine the importance of the monitored file in the host system based on the keywords.

3. The system of claim 2, wherein the analyzer includes:
a reception unit configured to receive a abstract of the monitored file from the monitoring agent;
a similarity analysis unit configured to check the presence or absence of a word in the abstract related to the keywords to determine the degree of importance of the monitored file; and
a registration unit configured to register the monitored file as the valuable file when the monitored file is determined to have the importance by the similarity analysis unit.

4. The system of claim 3, wherein the similarity analysis unit is configured to determine the importance of the monitored file by using a binary tree of the keywords.

5. The system of claim 3, wherein the registration unit is further configured to store information on the monitoring agent upon registration of the valuable file.

6. The system of claim 1, the monitoring agent comprising:
a file monitor configured to monitor a file in the host system;
a document converter configured to convert the monitored file into a text file; and
a document abstracter configured to produce the abstract of the text file.

7. An information property manager comprising:
a document converter configured to convert a given file containing sensitive information into a text file;
a keyword generator configured to extract one or more keywords from the text file, the keywords being used for determining whether or not a file to be monitored is a valuable file having sensitive information property;
a keyword storage unit configured to store the keywords; and
an analyzer configured to determine the importance of the monitored file based on the keywords.

8. A method for managing sensitive information property in a host system, comprising:
monitoring a leakage of the sensitive information property in the host system; and
figuring out the status of sensitive information property of the host system to determine whether or not the sensitive property has leaked.

9. The method of claim 8, said figuring out figuring out the status of sensitive information property of the host system comprising:
converting a given file into a text file;
extracting one or more keywords used to determine whether a file to be monitored is a valuable file having sensitive information property;
producing a abstract of the monitored file from the host system; and
analyzing the importance of the monitored file based on the keyword to determine whether or not the monitored file is the valuable file.

10. The method of claim 9, wherein said analyzing the importance of the monitored file includes:
receiving the abstract of the monitored file from the host system; and
determining the importance of the monitored file by checking the presence or absence of words related to the keywords in the abstract.

11. The method of claim 9, further comprising:
registering the monitored file as the valuable file when the monitored file is determined to have the importance.

12. The method of claim 11, wherein said registering the file as the valuable file includes:
storing information on a monitoring entity of the monitored file upon registration of the monitored file.
